(19) United States
(12) Patent Application Publication
(10) Pub. No.: US 2025/0333614 A1
(43) Pub. Date: Oct. 30, 2025

(54) SUSPENSION, COLLOID OR NETWORK COMPRISING LIQUID METAL DROPLETS BOUND WITH GRAPHENE-BASED PARTICLES, RESPECTIVE INK, TRANSPARENT STRETCHABLE CONDUCTOR AND OBTENTION PROCESS THEREOF

(71) Applicant: Universidade De Coimbra, Coimbra (PT)

(72) Inventors: Mahmoud TAVAKOLI, Coimbra (PT); Pedro Filipe ALHAIS LOPES, Coimbra (PT); Alexandre CHAMBEL, Coimbra (PT); Marta Sofia CALISTO FREITAS, Coimbra (PT); Afsaneh LALSANATI, Coimbra (PT)

(73) Assignee: Universidade De Coimbra, Coimbra (PT)

(21) Appl. No.: 18/860,738

(22) PCT Filed: Apr. 26, 2023
(86) PCT No.: PCT/IB2023/054321

§ 371 Date: Oct. 28, 2024

(30) Foreign Application Priority Data
Apr. 26, 2022 (PT) 117930

(51) Int. Cl. C09D 11/037; C09D 5/24; C09D 7/62; C09D 11/033; C09D 11/52

(52) U.S. Cl. CPC C09D 11/037; C09D 5/24; C09D 7/62; C09D 11/033; C09D 11/52

(57) ABSTRACT

Suspension or colloid comprising liquid metal droplets bound with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof; respective ink, transparent stretchable conductor and obtention processes thereof; also a conductor obtainable by applying a coating of suspension, colloid, network, or ink according to any of the previous claims over a substrate, and laser sintering said coating, in particular the conductor being an electrode or a circuit trace or a circuit. Applications include optoelectronic devices, pressure or strain sensitive piezo resistive composited, pressure or strain sensors, temperature sensors, electroluminescent devices, photovoltaic devices, memory devices or electrodes for energy storage devices.

### TECHNICAL FIELD

The present disclosure relates to material, methods, and process for synthesis, deposition, and laser processing of a graphene oxide coated liquid metal Nano particles, for applications in stretchable electronics, stretchable and flexible stretchable and flexible optoelectronics devices such as displays and photovoltaics, stretchable and flexible energy storage devices, sensors, and memory devices.

### BACKGROUND

The next generation of electronics devices including optoelectronics such as displays, and photovoltaics are desired to be thin, bendable, and stretchable. This permits transformation of existing surfaces into active surfaces that harvest energy and display information. For instance, transforming rooftops in the house or windows or dashboard of the car, or surface of the textile into smart surfaces with functions. There has been an increasing interest in implementation of stretchable Transparent conductive films (TCFs), for an emerging class of optoelectronics devices, such as stretchable thin-film displays, robotic e-skins, and interactive e-textile. However, unlike the flexible TCFs that is commonplace, fabrication of Stretchable Transparent Conductors (STCs) is still a major challenge.

Recent efforts on fabrication of transparent TCFs focused on the use of Ion-Conductors or high aspect ratio conductive fillers such as silver nano-wires (AgNWs), OR Carbon Nano Tubes (CNTs). Although ionic conductors have high stretchability, their electrical conductivity is very low, and they lack long-term stability due to water evaporation.

Transparent conductors based on high-aspect ratio conductors such as AgNWs have been investigated by several groups during the past years. High aspect ratio conductors percolate at low percentages of metal, thus permitting formation of conductive thin-films with large empty spaces. While promising, AgNWs are extremely costly, their deposition is challenging, and suffer from low adhesion to substrates, and poor contact at wire-wire junctions. These problems are obstacles against their scalable fabrication, and affect their performance against mechanical strain. The tolerance to strain and strain cycle is usually limited. This is associated with the brittle nature of the nanowire junctions and their high contact resistance.

Currently liquid metals (LMs), such as Eutectic Gallium Indium (EGaIn), are accepted as the primary choice in stretchable electronics, as they combine high electrical conductivity, extreme stretchability, excellent cyclic performance, self-healing property, and low Gauge Factor (GF). Therefore, development of transparent conductors based on EGaIn LM is highly desirable. However, EGaIn is inherently reflective, and even if applied as an ultrathin-film, it rapidly develops a non-transparent ultrathin (<3 nm) oxide shell.

These facts are disclosed in order to illustrate the technical problem addressed by the present disclosure.

### GENERAL DESCRIPTION

In an embodiment, materials and methods for low-cost and scalable fabrication of a stretchable transparent conductor based on specially engineered liquid metal nano droplets is shown. This is performed by surface modification of liquid metal droplets using graphene oxide sheets, or engineering composites in which liquid metal droplets bind to high aspect ratio carbon based sheets, such as Graphene Oxide (GO), followed by posterior laser assisted sintering. By designing the synthesis technique, and by changing the amount of graphene oxide in the formulation, the deposition technique and posterior sintering parameters, it is obtained a variety of composites that differ in transparency, conductivity, mechanical and chemical resilience. It was also engineered to be applicable through different methods of application, including spray coating, and thin-film application through roll coating or blade coating. In addition, it was developed a technique that permits adjusting various parameters of the film after its deposition through laser processing. This includes the film conductivity, density of its 3D percolating network and its transparency.

In one embodiment, it was used an Infrared fiber laser to sinter the ink into highly conductive, stretchable and transparent film. The laser sintering typically makes the non-conductive or very poorly conductive electrodes (e.g. in the order of Mega Ohm/Cm²) to highly conductive electrodes (ohm/cm² range).

If it is applied the laser over a film of LM nanodroplets that are not functionalized, the same doesn't happen and the film doesn't become transparent, nor stretchable. This is because the graphene oxide layer modifies the surface properties of the LM nanodroplets in terms of amount of existing gallium oxide, and as well the mechanical, thermal, and chemical stability of these particles.

In fact, application of EGaIn micro and nanomaterials has been demonstrated for soft electronics. EGaIn nanoparticles (NPs), with their gallium oxide shell and liquid core assembly, have been reported as a laser sensitive material, inducing the production of conductive patterns on soft substrates like PDMS (polydimethylsiloxane). The laser ruptures the nanometric Ga₂O₃ semiconductor shell around the EGaIn particles, resulting in formation of conductive EGaIn micropaths [7,8]. However, obtaining electrical transparency is unique feature that happens only by surface modification of the EGaIn nano particles. Moreover, the liquid metal droplets in previous works are very PH sensitive, and rapidly aggregate into larger spheres in highly acidic or basic solutions, thus limiting many of their applications, for instance in energy storage or sensor electrodes.

Although here Graphene Oxide (GO) is used for the purpose of surface modification, the overall concept can be extended to other materials that are able to bond to gallium oxide through galvanic replacement or surface charges. This material is then applied over a substrate as a thin-film, and sintered by laser.

By changing the laser parameters, such as power and speed, the film can be sintered, or ablated, to adjust the transparency and conductivity. In another embodiment, it was used a CO₂ laser to create a semiconductor composite, that can be used as a Memristor that is programable through application of current, and also a pressure sensitive film, whose electrical resistance changes upon application of mechanical pressure.

For making a transparent conductor, it is demonstrated laser-assisted self-assembly of EGaIn nanoparticles into a 3D percolating network, which results in formation of a 3D porous microstructure that permits light transmission. Surface modification of Liquid metal is generally performed by adding GO sheets into solution containing micro or nanodroplets of the liquid metal. Only a trace amount of GO (0.001% wt to 0.1 wt %) is enough for surface modification. GO addition results in two radical effects on the ink synthesis and formation of transparent conductor. First adding GO sheets result in pre-assembly of liquid metal droplets into a network of agglomerates encompassed by large sheets of graphene oxide. This results in precipitation of a highly concentrated ink that can be collected and coated over the substrate, compared to graphene-free LM nanodroplets that have to be spray coated. Second, upon laser sintering, the GO-EGaIn nanocomposite self-assemble into a porous 3D structure, a behaviour that is not observed in graphene-free LM nanodroplets (FIGS. 5 and 7). Formation of such 3D structure is beyond the reach of conventional lithographic techniques but is made possible through a simple laser-assisted self-assembly, thanks to the GO sheets.

Note that even without laser sintering, the applied film can be made slightly transparent by adjusting the dimensions of GO sheets, but the transparency is limited, and moreover the sample is not conductive, or is a very poor conductor. Laser sintering improves significantly the transparency and conductivity through various mechanisms. This includes partially reducing the graphene oxide, thinning the graphene oxide sheets, and aggregation and sintering of liquid metal particles. Laser assisted aggregation improves significantly the conductivity and as well the transparency. Conductivity is improved by 6 orders of magnitude, from mega ohms to ohms. That practically means nonconductive samples become conductive. Transparency is improved by reduce of the occupied surface and volume, due to aggregation of smaller particles into larger aggregates. Note that in all cases graphene oxide sheet act as guides, over which the liquid metal droplets bind. Therefore, their geometry, size and concentration has an important role is obtaining transparent conductors.

Depending on the type of the laser, and the applied power different scenarios occur, which permits adjusting the properties of the film. Although here laser sintering is demonstrated, this may be extended to other sintering technique such as thermal, or photothermal sintering.

The present disclosure relates to for the first time materials and methods for obtaining transparent conductors. This includes new ink formulation and synthesis technique, including low-concentration and high-concentration GO-EGaIn inks that can self-assemble into clusters for formation of 3D percolating network. It is also disclosed film deposition techniques, and is also shown for the first time laser processing of such composite, in which by adjusting the laser type and power, we obtain composites with partial sintering (kilo ohm conductivity range), full sintering (ohm range), and ablation. This permits fabrication of transparent or semi-transparent, flexible or stretchable electrodes, sensors, memristors, and energy storage devices.

Compared to the previous materials and methods for stretchable transparent conductors shown in the state of the art articles (e.g. nano tubes, silver nano wires), the disclosed invention permits a significant improvement both in conductivity and stretchability (over 6 times improvement compared to the highest records).

Graphene decorated EGaIn particles can potentially combine the advantages of graphene, i.e. high surface area, excellent mechanical and chemical resistance, with the excellent electromechanical properties of liquid metals, e.g. high electrical conductivity. Besides, the solid-liquid interface between the graphene and the liquid metal can enhance the charge transfer within the composite.

In addition, it is also disclosed that by coating GO over EGaIn nano particles, it can be developed thin-films that are chemically stable. This permits the using of nano particles of EGaIn in energy storage devices. It is known that the stability of EGaInNPs is dependent on their ultrathin (about 0.5-3 nm) Ga₂O₃ shell. When exposing to the highly alkaline electrolytes used in batteries and super capacitors, EGaInNPs lose their oxide shell and coalesce into a larger LM droplet, thereby losing their structure, and the surface area. For this reason, previous attempts with EGaIn as electrodes for supercapacitors were limited to using the liquid metal in its bulk form [11-13]. While these EGaIn-based SCs were shown to be stretchable, the areal capacitance of these devices remained on the order of 10-30 mF/cm², which is below that typical for SC energy storage applications. Making a thin-film from liquid metal nanodroplets stable in alkaline solution is the key for improving the energy storage capacity.

Also techniques for deposition and patterning of circuits based on this material are here disclosed. It is demonstrated Stretchable Transparent Conductors (STCs) with an unprecedented combination of stretchability about 1400% and conductivity about 2×10\hat{ }6 S/m. Unlike the STCs based on AgNW that require complex synthesis and deposition steps, here STCs are formed in few minutes. All fabrication steps including ink synthesis, coating, and laser sintering are achieved using low-cost and readily accessible equipment, and scalable processes. It is further disclosed laser-assisted fabrication of large electrode, stretchable displays, and sensing devices with complex geometries and micrometric features that can be fabricated using simultaneous laser reduction, patterning, and ablation of thin-films coated by GO@EGaIn (Graphene Oxide-EGaIn) composite.

Overall, this technique can serve as a versatile method for rapid prototyping, and scalable fabrication of laser reduced GO@EGaIn (Graphene Oxide-EGaIn) electrodes with micron sized features in few seconds. Unlike previous methods for deposition of graphene and GO, such as CVD (Chemical Vapor Deposition), spin coating, the simple coating technique used in this work, such as spray coating, thin-film application, or direct writing allows deposition of large area conductors. Although some of these coating techniques are performed manually, the resulting electrodes after laser treatment present an acceptable repeatability in terms of electrical resistance, and surface roughness in micrometric range. Therefore, this material composition, and the fabrication method developed, is a step towards scalable and low-cost fabrication of graphene based large area electrodes, transparent stretchable conductors, energy storage electrodes, sensing devices, among others.

It is disclosed a suspension or colloid comprising liquid metal droplets bound with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

In an embodiment, the liquid metal is gallium or a gallium alloy, and the graphene-based particles are selected from a list of graphene, graphene oxide, reduced graphene oxide, graphene quantum dots, carbon nanotubes, or combinations thereof [i.e. a netlike combination of filaments].

It is also disclosed a suspension, colloid, or network wherein the liquid metal droplets are coated with graphene-based particles.

In an embodiment, the weight ratio between graphene-based particles to liquid metal droplets is 0.0001-0.5%, preferably 0.001-0.1%.

It is also disclosed an ink comprising a concentrated network according to any of the claims 2-4, obtainable by separation of said network from a colloid or suspension according to claim 1.

In an embodiment, the ink is obtainable by:
suspending graphene-based particles in a first medium to obtain a first suspension, mixing liquid metal into the first suspension to obtain a mixture with the network of liquid metal droplets and graphene-based particles, and separating the concentrated network of liquid metal droplets and graphene-based particles from the mixture; or
suspending liquid metal droplets in a second medium to obtain a second suspension, mixing graphene-based particles into the second suspension to obtain a mixture with the network of liquid metal droplets and graphene-based particles, and separating the concentrated network of liquid metal droplets and graphene-based particles from the mixture.

In an embodiment, the ink is obtainable by suspending graphene-based particles in a first medium to obtain a first suspension and suspending liquid metal droplets in a second medium to obtain a second suspension, mixing said suspensions and separating the concentrated network of liquid metal droplets and graphene-based particles from the mixture, where the first medium and second medium are miscible [the first medium and second medium can be seen as co-solvents].

In an embodiment, the separating is carried out by precipitation, centrifuge, and/or filtering.

In an embodiment, the first medium is water or an aqueous solvent, in particular both first medium and second medium are water or an aqueous solvent.

In an embodiment, the second medium is ethanol or an alcohol-based solvent.

It is also disclosed a printable ink further comprising a binder for improving ink adhesion and/or viscosity, in particular for improving ink adhesion and/or viscosity for nozzle extrusion or screen printing.

It is also disclosed a conductor obtainable by applying a coating of suspension, colloid, network, or ink according to any of the disclosed embodiments over a substrate, and laser sintering said coating, in particular the conductor being an electrode or a circuit trace or a circuit.

In an embodiment, the conductor is transparent or translucid.

In an embodiment, the conductor is flexible or stretchable.

In an embodiment, the coating is carried out by spraying, rod-coating, slot-die, inkjet printing, aerosol jet printing, or blade coating.

In an embodiment, the conductor comprises conductive patterns obtainable by laser patterning or lithography.

In an embodiment, gallium alloy is an alloy of gallium-indium or gallium-indium-tin or eutectic gallium-indium.

It is also disclosed a process for obtaining a suspension or colloid, comprising binding liquid metal droplets with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

It is also disclosed a process for obtaining a network of liquid metal droplets bound with graphene-based particles, comprising binding liquid metal droplets with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

In an embodiment, the process for obtaining a suspension, colloid, or network includes coating liquid metal droplets with graphene-based particles.

In an embodiment, the first medium is water or an aqueous solvent, in particular both first medium and second medium are water or an aqueous solvent, in particular the pH of the aqueous solution containing graphene-based particles is between 1 to 6, preferably between 2 to 3.5.

In an embodiment, the second medium is ethanol or an alcohol-based solvent, in particular the liquid metal being 0.5-10% (w/w) of the ethanol or an alcohol-based solvent.

In an embodiment, the laser is a fiber laser having a wavelength ranging from UV to IR.

In an embodiment, the conductor comprises conductive patterns obtainable by laser patterning or lithography.

It is also disclosed a process to collect liquid metal particles from a suspension by adding a liquid suspension containing particles of opposite zeta potential than those of liquid metal for promoting a binding between the liquid metal and the added particles.

It is also disclosed a device comprising a suspension, colloid or network according to any of the disclosed embodiments, an ink according to any of the disclosed embodiments, or a conductor according to any of the disclosed embodiments.

In an embodiment, the device is an optoelectronic device, pressure or strain sensitive piezo resistive composite, a pressure or strain sensor, a temperature sensor, an electroluminescent device, a photovoltaic device, a memory device or an electrode for energy storage device.

### BRIEF DESCRIPTION OF THE DRAWINGS

The following figures provide preferred embodiments for illustrating the disclosure and should not be seen as limiting the scope of invention.

FIG. 1: Schematic representation of an embodiment of the fabrication of rGO@EGaIn composite, deposition and laser processing: A) composite synthesis via ultrasonic treatment and mixing; B) core-capsule structure of a single rGO@EGaIn particle; C) spray coating on a glass substrate; D) laser irradiation of the rGO@EGaIn films: from laser reduction to total film ablation.

FIG. 2: Illustration of results of an embodiment of a Laser parametrization for spray coated rGO@EGaIn films: A-i) Sheet resistance of the films processed at different pulse widths; B-i) Sheet resistance of the films processed at different laser powers; A-ii) a sample showing the different laser marks made at different pulse widths; B-ii) a sample showing the different laser marks made at different laser powers; C) Sheet resistance of the films processed at different laser speeds; D) transmittances of the different films processed at different laser powers.

FIG. 3: Illustration of results of A) XRD diffraction patterns of spray coated and laser processed GO@EGaIn films, with the amorphous and crystalline peaks detected for each sample. B) General profile of the obtained Raman spectra of the investigated samples in the 1000-1800 cm⁻¹ spectral range, with position of the maxima and the band assignment. The black bold spectrum is the experimental data; the five grey curves are the fitted bands, whose sum curve corresponds to the red line. Plots of I_{2D}/I_{G} (C) and of I_{D}/I_{G} (D), as well as the full-width-at-half-width of the D band (E) for the spectra of the studied samples as a function of the power of the laser. The bars are indicative of the expected error and include a statistical component and the experimental error in measuring the band intensities and bandwidths.

FIG. 4: Schematic representation of GO-EGaIn ink synthesis, deposition and activation.

FIG. 5: SEM imaging comparing laser processing on Liquid metal nano particles without (top), and with graphene oxide decoration (Bottom).

FIG. 6: Schematics of the GO@EGaIn (Graphene Oxide-EGaIn) network after deposition and after laser processing.

FIG. 6B: Shows increasing the amount of GO (from I to III), increases the transparency of the electrode after laser sintering.

FIG. 7: Illustration of the comparing optical transparency of laser processed liquid metal nanoparticles without GO decoration (bottom) that is non-transparent, the film of GO-EGaIn network (middle) that is semi-transparent, and the same film of GO-EGaIn network (top), with significantly improved transparency and conductivity.

FIG. 8: Results of the optical transparency of laser processed electrode (˜50-70%), and the same electrode further patterned by laser into honeycomb structure to further increase optical transparency to about 90%.

FIG. 9: the results of electrical resistance vs. Strain for transparent conductors made by materials and methods disclosed in this work.

FIG. 10: Illustration of the results of electrical resistance of the sample under 5000 repetitive cycles of 100%.

FIG. 11: Representation of electroluminescent device that uses laser sintered GO-EGaIn ink at both sides.

FIG. 12: Representation of Electroluminescent device under 600% strain.

FIG. 13: Photographic representation of a Multi/pixel electroluminicent device composed of a light emitting composite sandwiched between electrically conductive and stretchable electrode rows and columns fabricated through laser sintering and laser patterning of GO-EGaIn network.

FIG. 14: Representation of the results of an embodiment for comparing the electrical conductance and optical transparency of various technologies of the state of the art compared to this work/disclosure.

FIG. 15: Illustration of the results of an embodiment comparing the electrical conductance and maximum stretchability of various technologies of the state of the art compared to this work/disclosure.

FIG. 16: Illustration of the results of an embodiment where A) represents the synthesis of GO@EGaIn nanocomposite. B) SEM and optical images of B-i) Unsintered EGaIn B-ii) Sintered EGaIn B-iii) GO@EGaIn and B-iv) Lasered rGO@EGaIn when exposure to KOH drop. C) Schematic of the behavior of C-i) EGaIn C-ii) GO@EGaIn thin film exposure to KOH hydrogels. D) Schematic and SEM images of the GO@EGaIn thin film Left) before and Right) after laser. E) Supercapacitor construction stages: place three layers on the substrate, patterning and reduce GO to rGO. F) The optical images of supercapacitors in different deformed shapes.

FIG. 17: Representation of an embodiment of: A) Cyclic voltammogram of symmetric proposed supercapacitor for different scan rates. B) GCD graphs of soft-matter supercapacitor at different current densities for 3 μm thickness. C) Bar graphs of areal specific capacitance obtained with various thickness of active materials. D) Capacitance retention subject to charging/discharging cycles for supercapacitors without strain for up to 1000 cycles. E) Capacitance retention subject to charging/discharging cycles for supercapacitors with multiple strain cycles (10 times, 30%) applied in 20 and 300 charging/discharging cycles for up to 500 cycles. F) An illustration of the mechanism occurring in a two-electrode system for a proposed supercapacitor during charging and discharging.

FIG. 18: Illustration of the results that demonstrates the electrochemical cycling process A) Diagram of a supercapacitor obtained during charging and discharging (marked points represent sampling locations). B) Images of SEM in different stages, as shown in the above diagram. Insert) BSE images in the same locations of SEM.

FIG. 19: Representation of an embodiment containing: (Left) Schematic of a wirelessly chargeable supercapacitor that combines an energy harvesting antenna, power cast transmitter, and electronic components; (Right) Optical images of the integrated supercapacitor and antenna in various deformed shapes.

FIG. 20: Representation of a memristor device fabricated using GO coated liquid metal droplets as MEMRISTOR composite, and as well for sintered electrode

FIG. 21: Representation of a Memristor Behaviour observed in GO coated liquid metal composite

FIG. 22: Representation of a pressure sensitive screen, composed of liquid metal filled transparent conductor.

### DETAILED DESCRIPTION

The present invention relates to a colloid comprising liquid metal droplets coated with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

In an embodiment, graphene oxide (GO) liquid metal (LM) (herewith GO@LM) Composite or for Transparent Conductors was prepared. This composite is as well called GO decorated EGaIn LM droplets or GO coated LM droplets.

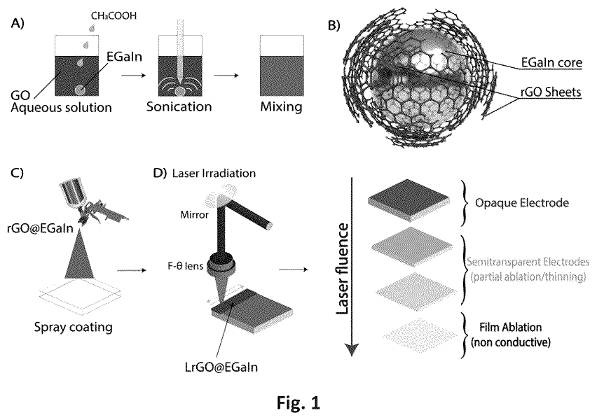

In one technique, it was prepared GO@LM (GO coated LM droplets) composite by using a GO suspension in water, bulk EGaIn and acetic acid. Note that upon mixture, the GO@LM (here also referred as GO@EGaIn) may convert to rGO@LM (reduced graphene oxide coated liquid metal), depending on the solution and its PH. Referring to FIG. 1A), the rGO@EGaIn colloidal solution was obtained by sonicating (˜20 min) 1 g of EGaIn into 20 ml of 0.4% (wt) graphene oxide water solution (Graphenea), with the intermediate addition of 1 ml of acetic acid (0.1 M). The GO/EGaIn weight ratio is only 0.08. The solution was then mixed for 3 min at 2000 rpm using a planetary mixer (Thinky ARE-250). This results in a suspension of partially reduced GO coated EGaIn particles—FIG. 1B). The solution was then spray coated over a substrate (i.e. glass or poly (methyl methacrylate), PMMA), using a spray gun. The sheet resistance of the spray coated samples, prior to the laser reduction was measured to be ˜(30±5) kΩ/sq, which is ˜3 orders of magnitude lower than that of spray coated EGaIn particles prior to the laser reduction. Finally, the spray coated sample was further reduced using a 20 W MOPA laser (JPT).

Here the term rGO@EGaIn refers to reduced graphene decorated EGaIn particle before laser processing. Note that during sonication the GO is partially reduced. To distinguish, it was used LrGO@EGaIn to refer to the material after being laser reduced.

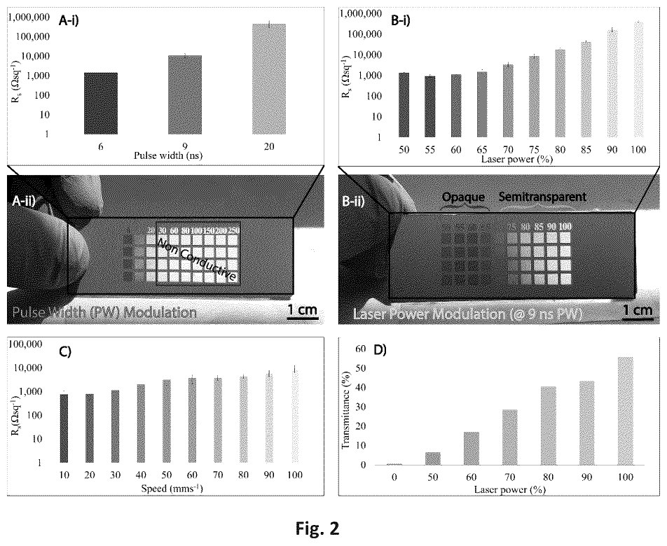

To evaluate the influence of different laser parameters (pulse width, power and speed) on LrGO@EGaIn films, it was prepared spray coated rGO@EGaIn films on glass, over which was laser reduced 40 squares of 3 mm² each, using the MOPA laser. Each 4 squares are repetitions of the same parameter, as evidenced on FIG. 2B-i). Referring to FIG. 2A-i), and FIG. 2A-ii), first it was evaluated the role of the laser pulse width. For that, laser power and speed were fixed at 85% and 50 mm/s, respectively; while the pulse width was changed with the frequency according to the pulse width/frequency dependency table provided by the laser manufacturer. This way, the pulse width was increased from 6 to 250 ns; while the frequency was progressively decreased between 350 kHz and 40 kHz. No conductivity was measured for the films processed at or above 30 ns (pulse width), as the particles were likely ablated too harshly, with no significant material left. The 9 ns pulse width sample was able to provide the best trade-off between conductivity and transparency. It can be also noticed from FIGS. 2A-i) and 2B-i) that, although the samples were manually spray coated, the final registered electrical resistance after laser reduction presents repeatable results.

After the laser power was evaluated—FIGS. 2B-i) and 2B-ii)-while fixing the pulse width at 9 ns, the frequency at 240 kHz, and laser speed at 50 mm/s. The power was varied. The sheet resistance increased along with the applied fluence, which happens due to excessive layer thinning of the material. Nevertheless, both opaque and semi-transparent conductive squares could be obtained. Therefore, we selected 70% power for the next samples. Note that, in this work our objective was to reach the best trade-off between transparency and conductivity.

Finally, it was varied the laser speed between 10 mm/s and 100 mm/s, as shown on FIG. 2C). As it can be seen, when the transparency is not important, low laser fluences are enough to reduce the sample, and achieve a sheet resistance below 1 kΩ/sq. The increase in the laser fluence increases slightly the sheet resistance but improves drastically the transparency. FIG. 2D) shows the dependency between the transmittance and the laser power. At 100% power, the optical transparency reaches to over 50%. Note that the increased sheet resistance does not mean that the actual electrical conductivity of the material is also decreasing. Instead, it only indicates that a material thinning is occurring, which results in higher sheet resistance.

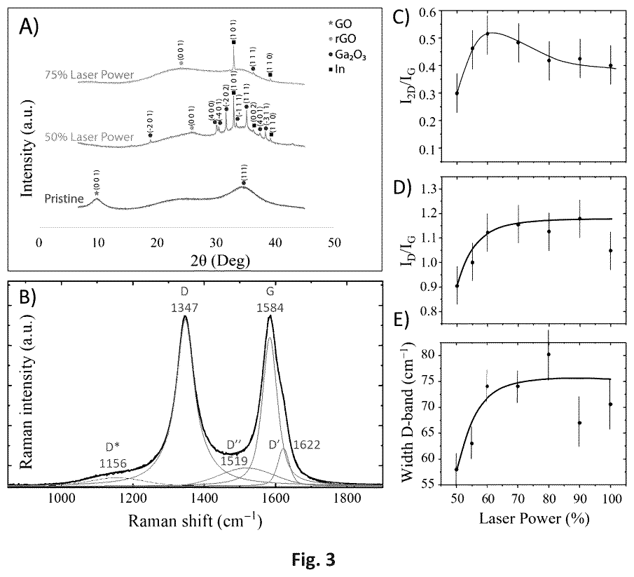

X-Ray diffraction (XRD) analysis in a range of 2θ angle from ˜7 to ˜45° was performed on the as-sprayed films, with and without laser processing for better understanding the crystal phases of the synthesized composites. This way, three types of samples were analyzed: one with no laser irradiation, which we refer to as a pristine sample, and two others processed at 50% and 75% laser powers, which correspond to a non-transparent and a semi-transparent sample, respectively. The results are shown in FIG. 3A). In the XRD pattern of the pristine sample, a sharp peak of GO in 2θ≈9.89° is evident that related to the (0 0 1) crystal plane. Also, in this sample one wide peak in the 2θ≈34.16° is visible that relates to the (1 1 1) plane of β-Ga₂O₃.

On the laser processed samples, peaks related to crystalline material are more visible, especially for the sample processed at 50% laser power (a non-transparent film). All the graphene oxide converted to reduced graphene oxide by applying laser treatment. Accordingly, the peak in 2θ≈9.89° completely disappears and a wide peak at 2θ≈25.47°, with lower intensity compared to the GO, appears that is related to the (0 0 2) plane of rGO.

In the 50% laser power diffraction pattern, we detected monoclinic β-Ga₂O₃ (JCPDS No. 01-087-1901.) peaks at 2θ values of: 18.88, 30.1, 30.4, 31.7, 33.4, 35.1, 37.5 and 38.4°, which correspond to (−2 0 1); (4 0 0); (−4 0 1); (−2 0 2); (−1 1 1); (1 1 1); (4 0 1) and (−3 1 1) planes respectively; as well as tetragonal indium (JCPDS No. 00-005-0642) peaks at 2θ: 33°, 36.4° and 39.2° that correlated with (1 0 1); (0 0 2); (1 1 0) planes, respectively.

By increasing the laser power to 75%, most of the peaks that were clearly observed in the previous samples disappear, due to the thinning of the layers. In this diffraction pattern, we only detected one main plane of monoclinic β-Ga₂O₃ (1 1 1) at 2θ≈35.1° and two main planes of tetragonal indium (1 0 1) and (1 1 0) at 2θ≈33° and 39.2°, respectively.

Surprisingly the MOPA laser induces local high temperature on the spray coated films, that further induces crystallinity of Ga₂O₃. Previously, only thermal sintering at >300° C. was reported to induce crystallinity of Ga₂O₃ in spray coated EGaIn nanoparticles, while laser sintered EGaIn remained amorphous [9].

In an embodiment, Raman spectroscopy was also used to further investigate the effect of laser processing. FIG. 3B) shows the general profile of the obtained Raman spectra of the investigated samples. FIGS. 3C)-E) present the plots of I_{2D}/I_{G} and of I_{D}/I_{G}, as well as the full-width-at-half-width of the D band for the spectra of the studied samples as a function of the power of the laser. From FIG. 3C), one can see that the I_{2D}/I_{G} ratio reaches a maximum for the laser power of ˜60% indicating that the reduction of the GO increases with the power of the laser. After this value of laser power the I_{2D}/I_{G} ratio start to decrease due to the effect of disorder (higher amounts of defects) increase, which tends to increase the intensity ratio. Note that 60% power is the threshold in which samples start to show some transparency. For laser powers of ca. 80% or greater the I_{2D}/I_{G} ratio reaches a nearly constant value, a result that combined with the data shown in FIGS. 3D) and 3E) seems to indicate that for laser powers greater than ca. 80% the degrees of reduction of the GO and of the disorder are not significantly different. Note that the laser power here mentioned is only indicative and relative to the type of laser. Changing the laser type, lens, or other properties will change the power of the laser. For instance, using a lower or higher power laser also changes the required parameters, and these parameters should be adjusted according to the laser used. Following, Graphene Liquid Metal Network for Stretchable Transparent Conductors will be described.

In an embodiment, materials and methods referred above were used in order to make a flexible transparent conductor. Here it is disclosed another novel formulation, synthesis, deposition, and laser processing process, that permits highly stretchable and highly conductive transparent conductors. This new synthesis is intentionally designed to be non-stable in the solvent, allowing for settling of a GO-EGaIn network. In contrast to the low concentration solution for spray coating, this new GO-EGaIn nanocomposite network can be collected as a highly concentrated matter, that can be applied through common thin-film application techniques.

Generally, the key challenge during the process of creating EGaIn particles is to overcome its high surface tension, which drives adjacent droplets to combine. To overcome this, a physical barrier should be created on the surface of droplets. In most works this is performed by the naturally forming gallium oxide layer on the surface of the EGaIn droplets. For water mediums with a pH between 3 and 11, the passivating oxide is stable [10]. However, simply sonicating liquid metal in water leads to an unstable colloidal suspension, where suspensions usually precipitate within tens of minutes. Changing the medium to ethanol instead of water, the formed EGaIn particles remained suspended up to several weeks. The high colloidal stability can be attributed to graphitic carbon coating formation during sonication. In addition to the gallium oxide these stabilizing outer shells prevent the liquid droplets from coalescing, subsequent growth, and formation of large sediments of LMP at the bottom of the container. Additionally, the average particle diameters can be decreased by increasing the sonication time, however, high sonication times could form indium enriched nanoparticles due to the selective removal of gallium, driving phase transitions from liquid to solid. These dispersions can be used for fabrication of electronics by using spray or inkjet [1] printing methods, however, a high ratio of ethanol/EGaIn should be used during sonication, which turns the ink deposition more challenging, specially to produce uniform films.

In an embodiment, for the synthesis of Graphene Liquid Metal Network: The motivation lies in having a highly concentrated ink of the particles produced by sonication, which can be applied using rod coating/thin film applicator or other similar techniques. The printing time will be significantly reduced, compared with the typical low concentration LMPs suspension. The synthesis method was formulated to avoid recoalescence of EGaIn particles into larger droplets, while permitting them to cluster into networks. The formulation was engineered to be able to produce an ink filled with spherical EGaIn particles that have liquid cores with a reduced thickness of gallium oxide shells. The gallium oxide shells, are high aspect ratio sheets that bind to the liquid metal particles.

Although these sheets can be cut into smaller sheets, it is generally preferred to maintain large sheets to form transparent conductors. This is because these large sheets determine how the liquid metal droplets self-assemble into percolating networks that leave holes that permit light transmission. That means that, as the liquid metal particles bind to these GO sheets, due to surface potentials or galvanic replacement, we can engineer the size of high aspect ratio sheets, so that after deposition of the film from this ink, they do not fully cover the whole surface of the substrate, and leave some holes for transmission of light.

To do so, it was performed dispersion of EGaIn in ethanol as medium, and the sonication time was reduced to a few minutes. For instance in one embodiment the sonication time was only 10 min compared to over 1 hour for previous works. In this embodiment, it was sonicated 0.4 g EGaIn in 20 g Ethanol on an ice bath to avoid the formation of indium enriched particles and the growth of the gallium oxide shells. Using ethanol as medium reduces particles recoalescence compared to water. However it can cause coating the particles by carbon. To collect the particles, a cosolvent system of ethanol and GO water dispersion was formulated, exploring the interactions between GO sheets and LMP. Encapsulation of EGaIn liquid metal nanoparticles (LMNPs) using graphene oxide (GO)[2, 10] and reduced GO (rGO)[11,12] have been used to change the LMNPs surface properties. When water is used as the solvent, adding GO is sufficient to cause GO to form a conformal encapsulating layer on the surface of dispersed liquid metal droplets. However, in ethanol, no such encapsulation occurs [3].To overcome this drawback, it was formulated a cosolvent system of ethanol and GO water dispersion (pH 2.2-2.5). When mixed with ethanol, the pH of the cosolvent increases. The resultant processing cosolvent acidic exposes the bare metal of the LMPs by the dissolution of the gallium oxide shell [11,12], enabling the interaction of the GO sheets and LMPs. This process is governed by the positive Zeta potential of the LMNPs and the negatively charged GO sheets. GO tends to bond to the surface of LMPs to balance the charge. LMPs aggregation happens due to electrostatic interaction between several LMPs and larger GO sheets. Consequently, this results in formation of small clusters of LMPs mounted on high aspect ratio sheets of graphene oxide. The LMP acts as an anchoring point for exposed surface GO clusters. Surface LMNPs that are attached to one GO sheet can interact with other closer LMNP free GO sheet surface, thus resulting in formation of larger networks of GO-LMNP that finally precipitate by gravity. Using our optimized relation between GO and LMPs, the precipitation of the LMPs and graphene is balanced, meaning that GO has the specific amount to establish the precipitation mechanism. GO in excess degrades the process since each GO sheet will have much less LMPs attached, implying fewer anchoring points to join to other LMPs depleted clusters. Additionally, excess GO will increase the cosolvent viscosity, degrading the precipitation process. In opposition, if GO quantity is too low there are not enough close clusters on the volume of the medium to promote the interaction (the clusters are not confined against each other). However, the required quantity of GO for gathering all the dispersed particles depends on the particles surface area, for example, when the same amount of LM is sonicated for 2 h instead of 10 min the required GO amount should be 7 times higher to provoke precipitation.

When compared to the previous technique disclosed, it was reduced GO to EGaIn ratio by ˜50 times (from 0.08% to ˜0.0015). We as well changed the synthesis process and the solution. In one case, we sonicated 20 g of Ethanol, 50 mg of graphene oxide (GO) and 0.4 g of EGaIn for 10 minutes with 90% power to make the GO-EGaIn ink. Afterward, 100-150 mg of GO (4 mg per ml) are added dropwise (3 drops) to the solution and manually mixed. This results in deposition of the particles on the bottom of the flask. The particles settle due to the electrostatic adsorption at their surface. In this case, the highly concentrated ink can be separated by removing the excess ethanol from the top of the flask. This provides advantages over low viscosity inks with liquid metal EGaIn droplets that should be applied using spray coating or similar. The use of ethanol with the combination of acidic PH in the GO dispersion, play an important role to avoid Ga oxidation, and GO coating. In similar processes, other carbon products, such as graphene quantum dots, carbon particles, or tubes may be as well used to replace the GO.

To make a stretchable transparent conductor, the concentrated GO-EGaIn network is then applied over a transparent elastic polymer such as Styrene-isoprene block copolymers or PDMS, using a thin-film applicator or a rod.

Note that the amount of GO has a significant role in changing the properties of the composite both before, and after laser processing. GO improves mechanical and chemical properties of the nano particles. But excessive GO can reduce the conductivity of the samples.

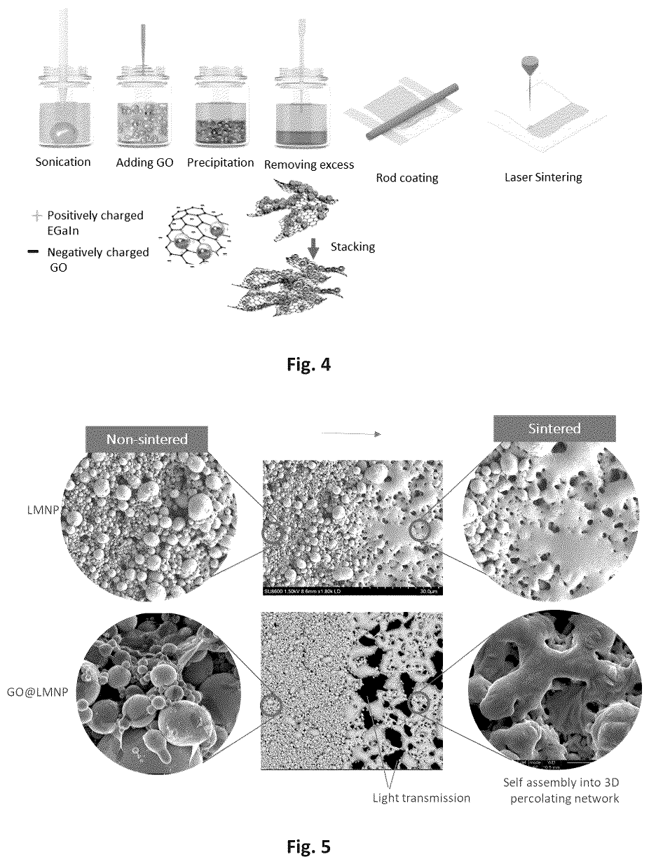

After drying, it was used a MOPA (master oscillator power amplifier) laser with Infrared wavelength to “activate” the ink. A rectangle (20×50 mm) was hatched with a line spacing of 0.01 mm using 20% power. The resistance of the sample after laser sintering is ˜4 Ω. This is over 100 times of improvement compared to the previous formulation disclosed in this patent that had an electrical resistance of over 500 Ω. The laser “activation”, provokes further reduction and thinning of GO, as well as removal of gallium oxide that results as self-assembly of liquid metal droplets around the GO sheet, thus resulting in the conductivity and enhancing the transparency. FIG. 4 shows the summary of the process, from synthesis, deposition, and laser processing. After laser sintering, the ink self-assembles into percolating networks of EGaIn.

Note that if it is performed laser sintering over a film of LM nanodroplets that are not functionalized by GO, the film doesn't become transparent.

In an embodiment, FIG. 5 shows SEM imaging comparing laser processing on Liquid metal nano particles without (top), and with graphene oxide decoration (Bottom). As can be seen, without GO the resulting device covers the surface which blocks the light transmission.

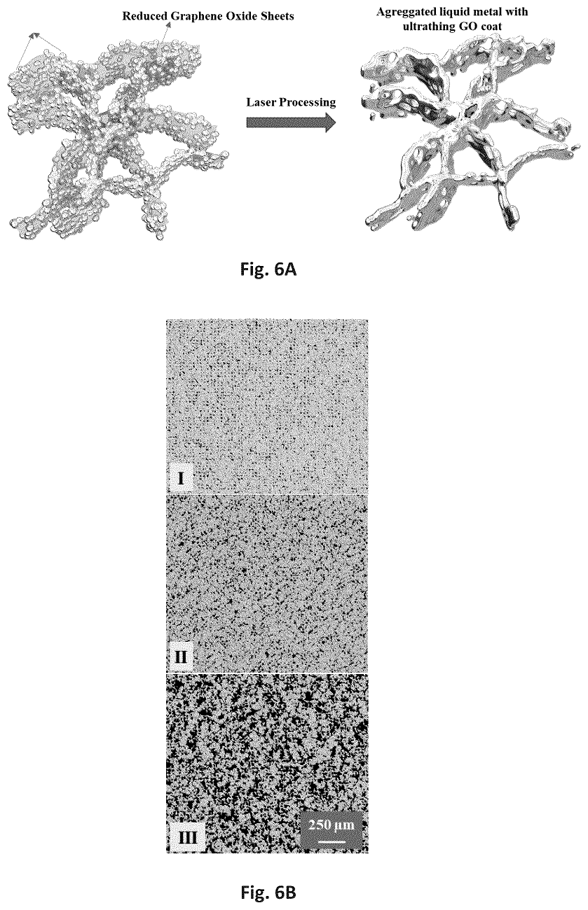

In an embodiment, FIG. 6 shows schematics of the GO@EGaIn network after deposition, and after laser processing. As can be seen, the partially reduced GO sheets act as guidelines for attachment of EGaIn droplets. When the laser scans the electrode, these EGaIn droplets coalescence into conductive lines, that occupy less volume compared to the sample prior to laser processing. Therefore, they leave empty spots that permit the light transmittance. Note that the same doesn't happen in absence of GO.

In an embodiment, FIG. 6B shows an optical image of 3 electrodes, in which the GO amount was increased (from I to III), resulting in increased transparency.

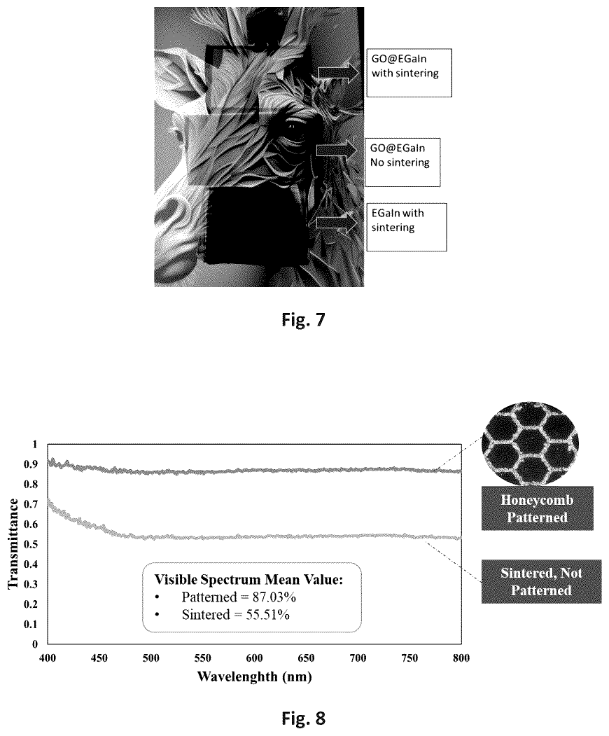

In an embodiment, FIG. 7 shows the resulting film of laser sintered EGAIN droplets without GO which is non-transparent (bottom), and a film of GO-EGaIn deposited over a transparent substrate (middle), which is slightly transparent and non-conductive or very poorly conductive (kiloΩ-megaΩ) range depending on the GO concentration and film thickness. Top image shows the same film after laser processing, which is both transparent and highly conductive (<10Ω).

In an embodiment, FIG. 8, shows the optical transparency of a laser sintered sample (˜55-70% transmittance), and another electrode laser sintered and laser patterned to honeycomb structure (˜90% transmittance). Laser patterning can increase the transmittance by selectively removing materials from the film. However, for most applications it is not necessary.

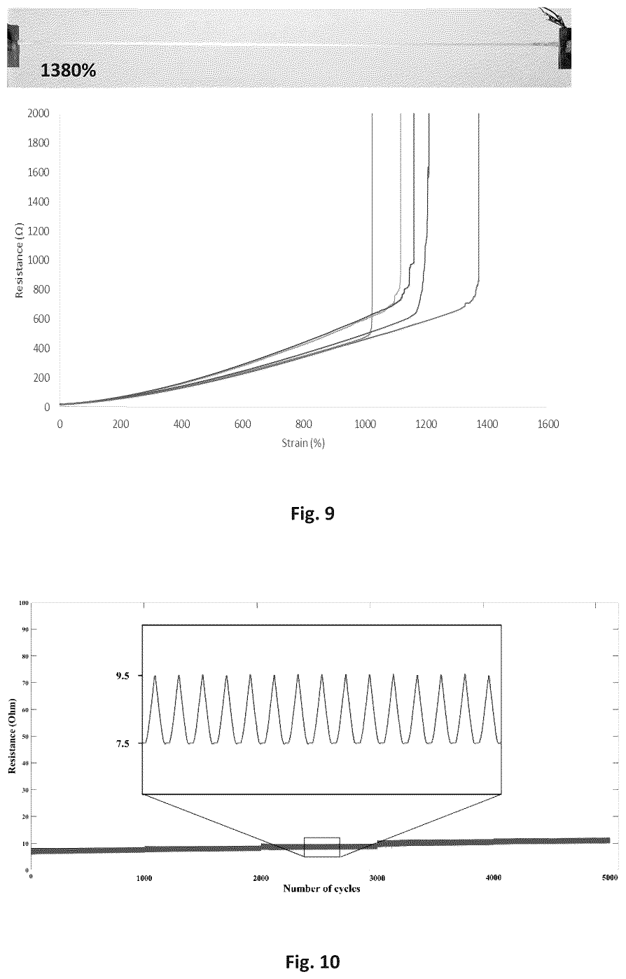

In an embodiment, FIG. 9 shows an example of conductive semi-transparent device and the electromechanical characterization of the sample. The sample maintains its high electrical conductivity even when subject to large mechanical strains. As can be seen the transparent conductor withstands 1300% of strain, and its electrical resistance remains below 10 Ω even at 150% of strain. FIG. 10 shows 5000 strain cycles of 100%. The sample is able to maintain a stable behavior even at this harsh condition.

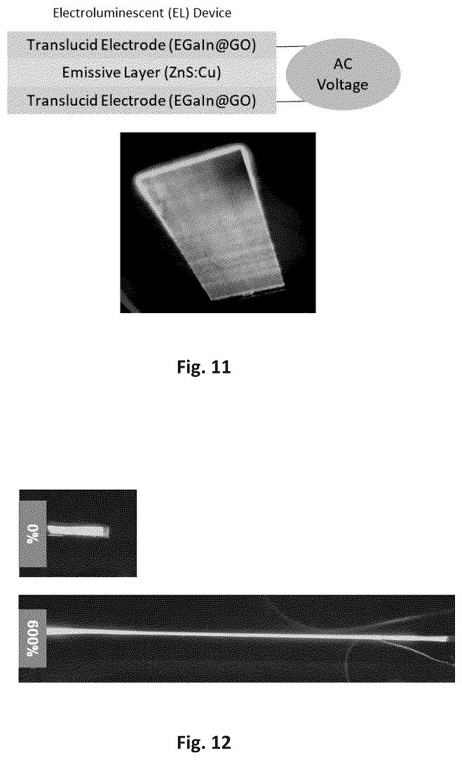

In an embodiment, FIG. 11 shows an example of a stretchable electroluminescence device in which both sides of the conductor are GO-EGaIn ink. In this electroluminescent device, the middle layer includes a composite from an elastic material and electroluminescent powder. The top and bottom layer are composed of the same GO-EGaIn ink. This configuration functions without the addition of a dielectric layer with high dielectric constant, which is common in electroluminescent devices. Therefore, the fabrication is simpler. In addition, the electroluminescent light can be seen from both sides of the electroluminescent device equally.

In an embodiment, FIG. 12 shows an electroluminescent device under extreme strain conditions.

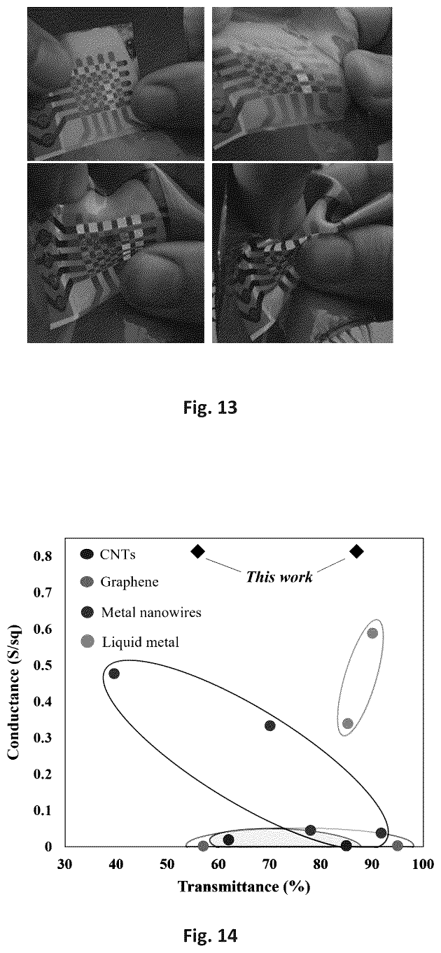

In an embodiment, FIG. 13 shows a multi-pixel electroluminescent device composed of conductive rows and column electrodes made with GO-EGaIn network and laser sintered and laser patterned using the techniques previously disclosed.

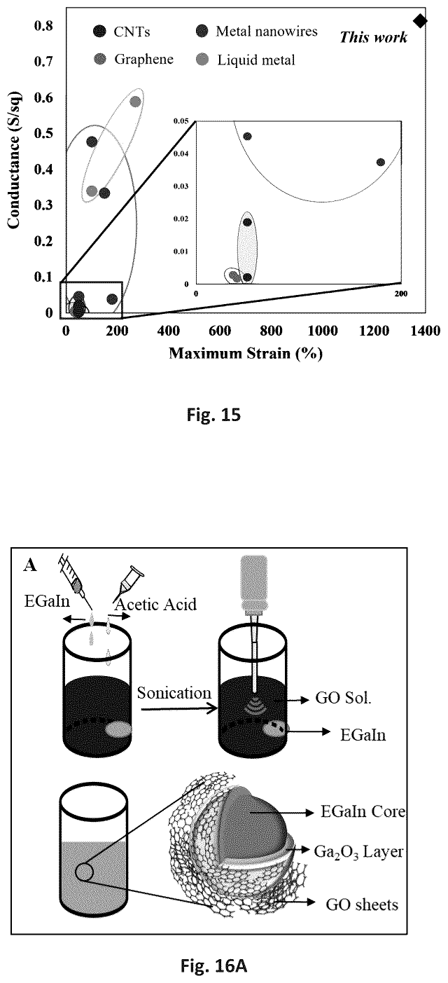

In an embodiment, FIGS. 14 and 15 show the optical transmittance, electrical resistance, and strain tolerance of transparent conductors made by this method compared to previous works, that demonstrates a clear and significant improvement over the state of the art. The current invention permits improving significantly electrical conductivity, and maximum strain tolerance of transparent conductors. Compared to transparent conductors based on silver nano wires, liquid metal provides better strain tolerance due to its fluidic nature. However, till now it was not possible to make liquid metal based transparent conductors based on the self-assembly of the liquid metal droplets, guided by the graphene oxide sheet to which they are bound.

Graphene oxide sheets act as guidelines for liquid metal droplets. Liquid metal droplets selectively bind to these sheets, and therefore they do not spread all over the surface, permitting slight transmittance of light. Laser sintering, further combines these particles to more compact form, creating additional spaces that increase light transmittance.

Liquid metal droplets without GO coating are as well smearing to touch. The GO@EGaIn as well improved the mechanical resistance of the particles to rupture, and improve the smearing behaviour.

It will be now disclosed the Graphene Liquid Metal Electrode for Energy Storage.

The use of EGaIn as electrodes in batteries and energy storage devices are promising, due to mechanical deformability, high electrical conductivity, dendrite-free operation and self-healing of LM.

In an embodiment, high performance, EGaIn-based SCs and batteries can be formed by using GO coated EGaIn nano particles (NPs). Thin-film electrodes made by this composite has extremely higher chemical stability, compared to the EGaInNPs without GO. This allows for the first time exposing EGaInNPs the use of EGaInNPs as energy storage electrodes that are stable, in the presence of highly acidic or alkaline electrolytes. In addition it is disclosed a facile, rapid, low-cost, and scalable fabrication technique based on single step laser processing of GO@EGaIn. This allows fabrication of conductive interdigitated geometries from a pre-coated film in a few minutes. We use an accessible 1064 nm wavelength Infrared Laser (IR) that converts the GO@EGaIn to reduced graphene oxide (here called LrGO@EGaIn) nanocomposite. At higher powers, this laser is able to simultaneously pattern the film to the desired geometry through full or partial ablation.

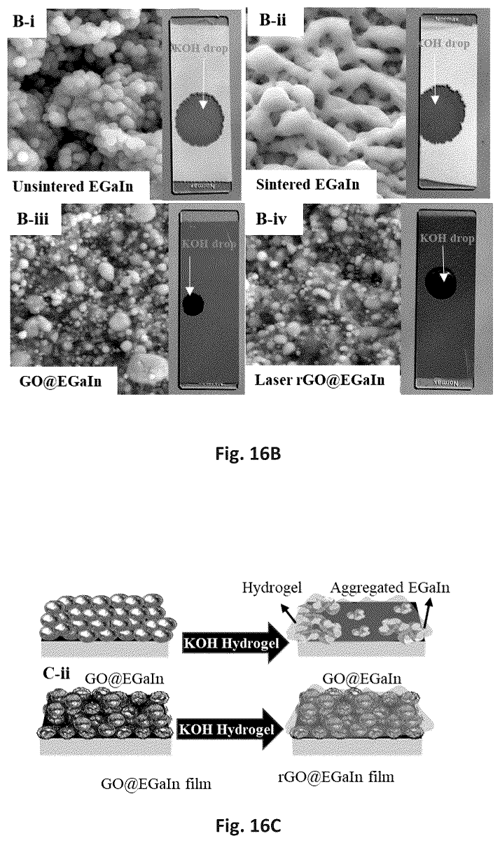

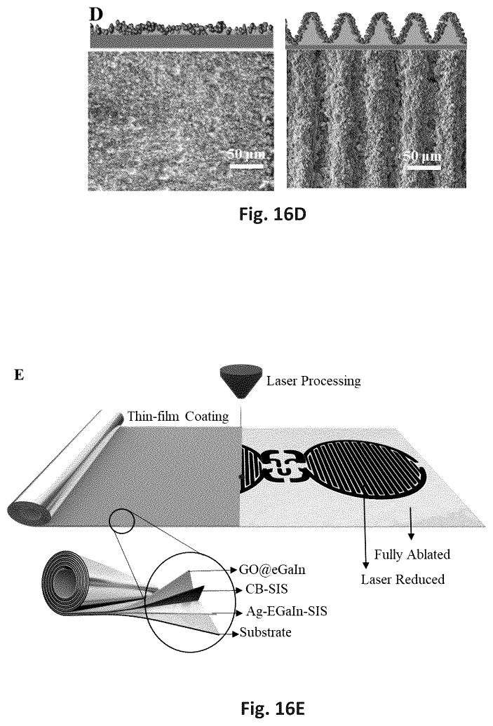

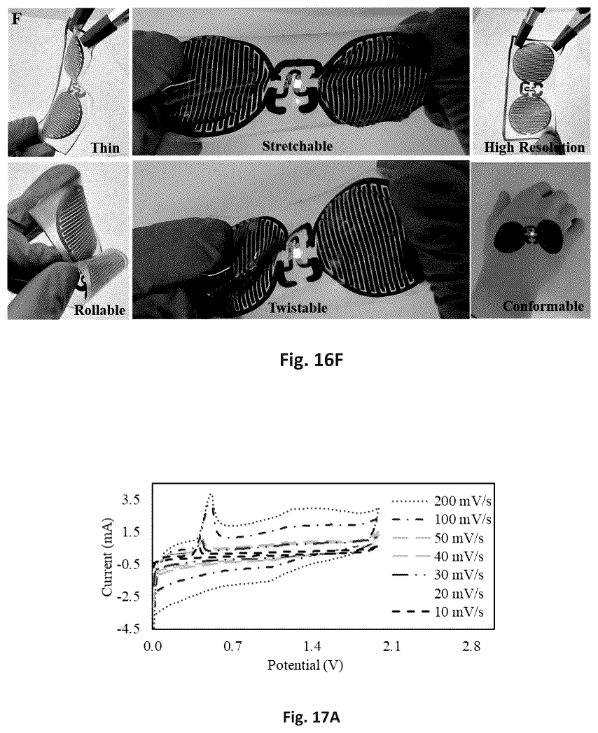

Referring to FIG. 16A, GO-coated EGaIn nanodroplets were first synthesized by sonication of 1 g bulk EGaIn in 20 ml solution of water based GO solution. It is known from the literature that the stability of EGaIn nanodroplets is dependent to their ultrathin (<3 nm) Ga₂O₃ shell (FIG. 16B-i). Through fiber laser radiation, we can eliminate the Ga₂O₃ shell, for a significant improvement in conductivity (FIG. 16B-ii). Unfortunately, neither the EGaInNPs, nor the laser sintered LM scaffolds are stable when exposed to a highly alkaline solution. Optical images in FIG. 16B-i and ii, show that few seconds after exposure to a drop of 6M KOH aqueous solution, LM droplets/scaffolds dewed from the surface, and aggregate into balk LM and therefore the background of the coated glass becomes visible. In contrast, the film with GO encapsulated EGaIn composite stays intact after exposure to the same 6M KOH aqueous solution (FIG. 16B-iii, iv) This approach allows utilization of EGaIn nanodroplets as active electrodes in redox reactions. FIGS. 16C-i and ii show schematically the role of the GO sheets in protecting EGaIn from chemical corrosion.

In an embodiment, it was used a simple manual spray coating gun to form the GO@EGaIn thin film over various substrates on a hotplate. Then a IR MOPA laser (1064 nm) was used, both for patterning of the desired geometry through full ablation of the coated material from the film (e.g. formation of the interdigitated architecture), and for further reduction of the GO layers into reduced graphene oxide (rGO). In the case of energy storage electrode, laser treatment can improve surface area (FIG. 16D) and energy storage capacity, but even without the laser reduction the device functions. In the particular case of energy storage, laser reduction can be as well performed by other wavelengths and other types of lasers, such as CO₂ laser. Laser reduction further decreased the sheet resistance from ˜30 KΩ/□ to ˜1 KΩ/□.

In an embodiment, and referring to FIG. 16E, the soft-matter supercapacitor can be produced from pre-coated films in a few minutes through simultaneous laser reduction and patterning (ablation). The film itself contains a highly stretchable Ag-EGaIn-SIS (styrene-isoprene block copolymers) [16] as a first current collector (CC), followed by a Carbon Black-SIS (CB-SIS) film as a second CC. Both are applied by a thin-film applicator and the binder-free rGO@EGaIn nanocomposite is applied through spray coating. FIG. 16F demonstrates an example of a thin-film SC produced with this technique, showing that it can be stretched, bent, twisted or rolled.

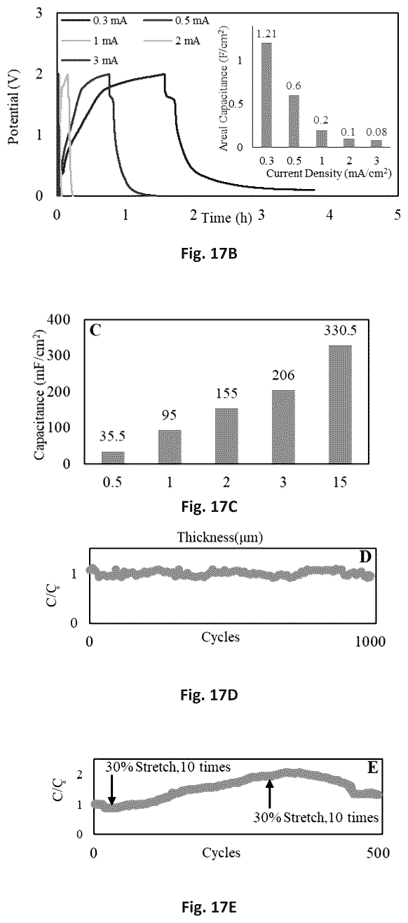

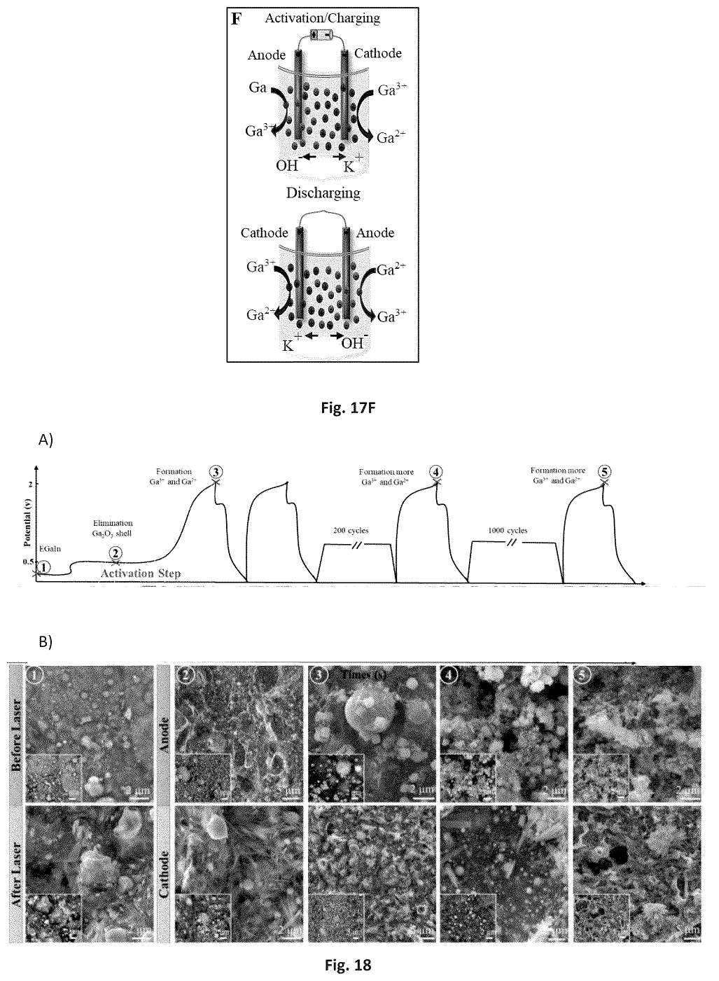

In an embodiment, cyclic voltammetry (CV) was used in order to study the electrochemical behaviour of two-electrode symmetric rGO@EGaIn SCs in presence of 6M KOH hydrogel electrolyte. Referring to FIG. 17A, CV curves on rGO@EGaIn were listed at a potential window of 0-2 V with scan rates of 10-200 mV s⁻¹. Redox peaks in the CV plots of the rGO@EGaIn//rGO@EGaIn SC are related to Faradaic redox reactions, and indicates the pseudocapacitive behavior of the SC. Additionally, the overall form of the CV graphs remain nearly unchanged during the increase in the scan rate. This demonstrates that increasing the scan rate, improves the mass transport, and reversibility of these electrodes. FIG. 17B shows the galvanostatic charge/discharge (GCD) plots of SC at various current densities and in the potential window range from 0 to 2 V. In agreement with the CV plots, the nonlinear shape of the GCD plots indicates the faradaic behaviour of the rGO@EGaIn electrodes. Furthermore, the low amount of IR drop (˜0.17V) illustrates the low internal resistance of the rGO@EGaIn electrodes. FIG. 17B inset demonstrates the changes of the areal capacitances in different current densities, ranging from 1.2 F/cm² for 300 μA/cm² charge/discharge current to 85 mF/cm² for 3 mA/cm². As expected, the areal-specific capacitance is increased when decreasing the current densities. Note that these results are all based on a SC with an electrode thickness of 3 μm. FIG. 17C demonstrates the areal-specific capacitance, for various electrode thickness, ranging from ˜0.5 μm to ˜15 μm, for a discharge current density of 1 mA/cm². We observe a quasi-linear increase in the areal capacitance in the ˜0.5 μm to ˜3 μm electrode thickness (˜6× increases in thickness results in ˜6× increase in the areal capacitance). However, this doesn't hold after this range, as the areal capacity of the ˜15 μm thick electrode is only 1.6× of the ˜3 μm thick electrode.

FIG. 17D demonstrates the ratio of the areal capacitance to the initial capacitance as a function of the number of cycles. The capacitor shows cycling stability, retaining ˜98.4% of their initial capacitance after 1000 charging/discharging cycles at 3 mA/cm². Insets show a zoom window from four cycles at beginning (after 3 hours) and at the end of measurement (after 32 hours).

FIG. 17E, shows the SC behaviour when subject to 30% mechanical strain. FIG. 17F, schematically shows the electrochemical reaction during charging/discharging in each of the electrodes. As both electrodes are made from the same composite, at the beginning there exist no potential differences between them. Therefore, the redox reaction is non-spontaneous and is activated by the supplied electrical energy, which initiates the reaction. Therefore, right after the fabrication of the SC, we perform a one-time activation step, to form the required metal Ions for creation of the potential difference between the electrodes. During the charging process, the KOH is converted to K⁺ and OH⁻ ions that move towards the electrode with the opposite charge (pH ˜14). During the oxidation/reduction reaction, in the Anode the Ga is converted to a GaO₃³⁻ ion during the charging process (Oxidation), while at the same time GaO₃³⁻ ions are converted to Ga²⁺ ions in the cathode (Reduction). The opposite process occurs during discharge. According to Pourbaix diagram the following reaction happens:

$${Ga}^{2 +} + 3 {H}_{2} O ↔ {GaO}_{3}^{3 -} + 6 {H}^{+} + {e}^{-}$$

$${E}_{a} = 1.868 - 0.3 \; 546 pH + 0. 0591 log \frac{[ {GaO}_{3}^{3 -} ]}{[ {Ga}^{2 +} ]} .$$

In an embodiment, FIG. 18, demonstrates the electrochemical cycling process.

FIG. 18 represents A) Diagram of a supercapacitor obtained during charging and discharging (marked points represent sampling locations). B) Images of SEM in different stages, as shown in the above diagram. Insert) BSE images in the same locations of SEM.

In an embodiment, FIG. 18, shows the that the results seem to indicate that indium is migrating out of the EGaIn droplets during the charging process. The reason for the plateau at 0.5 volts is related to the elimination of the protective layer of gallium oxide (Ga₂O₃) in some of the particles, which allows contact between the electrolyte and the oxide-free liquid metal, thus resulting in formation of gallium ions (GaO₃³⁻ and Ga²⁺) and indium oxide (In₂O₃) particles. The elimination of Ga₂O₃ layer at 0.5V is consistent with a previous work that investigated switchable surface activity of liquid metal [14].

Further charging results in the release of more gallium ions, and indium oxide is produced as a secondary product. Comparing the anode and cathode scanning electron microscopy images, one can see that the indium particles formed on the anode are cubic, whereas in the cathode they are spherical. This is due to the different amounts of oxygen on the two electrodes. As the number of cycles increases, the particle size of the alloy bulk particles decreases, indicating that more gallium ions are released to participate in the redox process. It is also interesting to observe that although during the electrochemical cycling some of the Ga₂O₃ is eliminated, the GO is still able to protect the EGaIn NPs from coalescing over the span of 1000 electrochemical cycles.

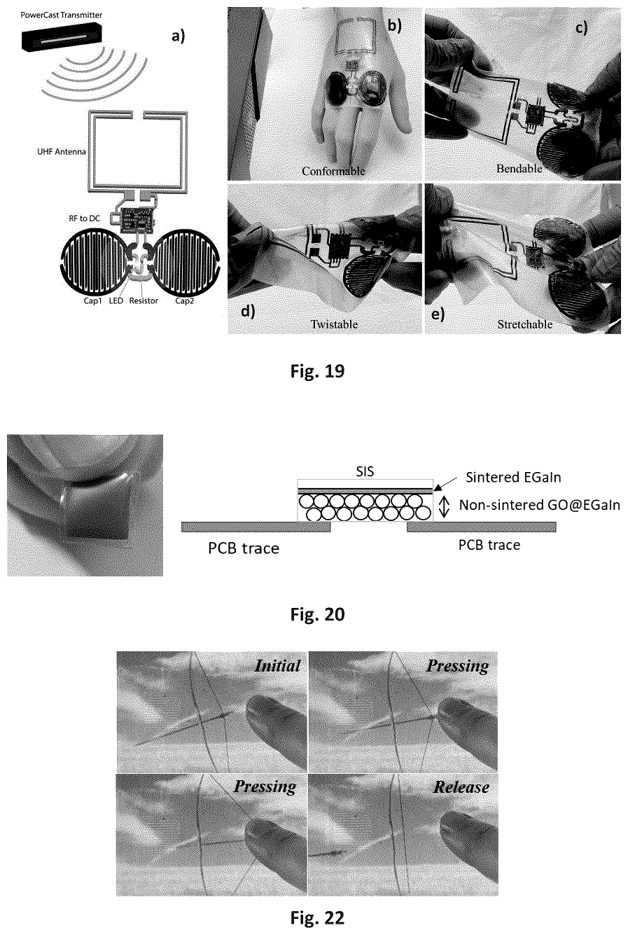

In an embodiment, FIG. 19 shows an integrated patch composed of a dipole antenna for far-field energy harvesting, which is coupled to an RF to DC (P1110B RF) board for converting the energy to a constant DC voltage and GO@EGaIn super capacitors for energy. The circuit is on a soft and stretchable thin-film SIS elastomer substrate. Notably, all circuit components, i.e. antenna, electrical interconnect, and supercapacitors were patterned rapidly from the same coated film. We first charged the supercapacitor, using a transmitter antenna, and then used the stored energy in the SC to light an LED.

It is also disclosed, a memristor and pressure sensitive device based on go coated liquid metal composite. The GO coated liquid metal composite as well shows Memristor behaviour. Here it is shown for the first time such behaviour through fabrication of a device composed of a partially laser sintered composite of GO-EGaIn, as depicted in FIG. 19. Here it was used a CO₂ laser to only partially sinter the composite. This step permits to make a composite that has memory and sensing devices. On the other hand, the top electrode shown in FIG. 19, is fully sintered using an IR laser to make a highly conductive electrode, interfacing the memristor composite.

In an embodiment, FIG. 20 shows the memristor behaviour of the device.

In addition to Memristor device, this composite is a pressure sensitive film, whose electrical conductivity improves, when a pressure is applied.

Therefore, combination of this composite and two types of lasers, and changing laser power can be used in order to fabricate complex sensors or memory devices.

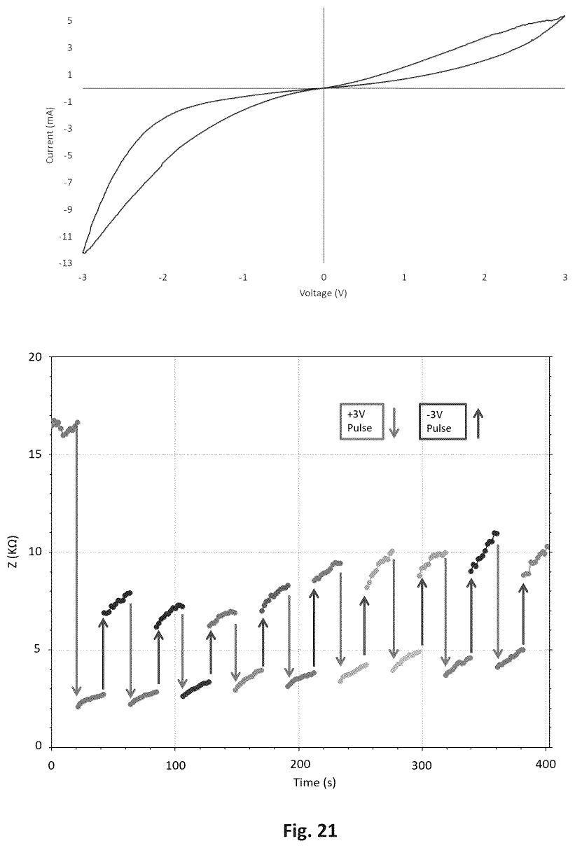

In an embodiment, FIG. 22 shows a transparent pressure sensitive electrode made by laser processing and patterning GO-EGaIn network. This film is applied over a mobile phone screen to make a transparent pressure sensor which permits taking into account the pressure applied by the user, as an input for games or other programs.

The term “comprising” whenever used in this document is intended to indicate the presence of stated features, integers, steps, components, but not to preclude the presence or addition of one or more other features, integers, steps, components or groups thereof.

The disclosure should not be seen in any way restricted to the embodiments described and a person with ordinary skill in the art will foresee many possibilities to modifications thereof. The above described embodiments are combinable.

The following claims further set out particular embodiments of the disclosure.

### REFERENCES

1. Liu, S. et al. Laser Sintering of Liquid Metal Nanoparticles for Scalable Manufacturing of Soft and Flexible Electronics. ACS Appl. Mater. Interfaces 10, 28232-28241 (2018).
2. Liu, S., Reed, S. N., Higgins, M. J., Titus, M. S. & Kramer-Bottiglio, R. Oxide rupture-induced conductivity in liquid metal nanoparticles by laser and thermal sintering. Nanoscale (2019) doi: 10.1039/c9nr03903a.
3. Creighton, M. A., Yuen, M. C., Morris, N. J. & Tabor, C. E. Graphene-based encapsulation of liquid metal particles. Nanoscale 12, 23995-24005 (2020).
4. Wang, Y., Wang, S., Chang, H. & Rao, W. Galvanic Replacement of Liquid Metal/Reduced Graphene Oxide Frameworks. Adv. Mater. Interfaces 7, 2000626 (2020).
5. Saborio, M. G. et al. Liquid Metal Droplet and Graphene Co-Fillers for Electrically Conductive Flexible Composites. Small (2020) doi: 10.1002/smll.201903753.
6. Duan, M. et al. EGaIn Fiber Enabled Highly Flexible Supercapacitors. ACS Omega 6, 24444-24449 (2021).
7. So, J.-H. & Koo, H.-J. Study on the Electrochemical Characteristics of a EGaIn Liquid Metal Electrode for Supercapacitor Applications. Trans. Korean Hydrog. new energy Soc. 27, 176-181 (2016).
8. Kim, M. G. et al. All-Soft Supercapacitors Based on Liquid Metal Electrodes with Integrated Functionalized Carbon Nanotubes. ACS Nano 14, (2020).
9. Hynes Navasingh, R. J. et al. Graphene-based nano metal matrix composites: A review. in Nanocarbon and its Composites: Preparation, Properties and Applications (2018). doi: 10.1016/B978-0-08-102509-3.00006-7.
10. Alotaibi, F., Tung, T. T., Nine, M. J., Coghlan, C. J. & Losic, D. Silver Nanowires with Pristine Graphene Oxidation Barriers for Stable and High Performance Transparent Conductive Films. ACS Appl. Nano Mater. (2018) doi: 10.1021/acsanm.8b00255.
11. Abbasi, R. et al. Photolithography-enabled direct patterning of liquid metals. J. Mater. Chem. C 8, 7805-7811 (2020).
12. Kim, M. gu, Brown, D. K. & Brand, O. Nanofabrication for all—soft and high-density electronic devices based on liquid metal. Nat. Commun. 11, 1-11 (2020).
13. Tavakoli, M., Paisana, H., De Almeida, A. T. & Majidi, C. Liquid metal fusion with conductive inks and pastes. (2020).
14. Khan, M. R., Eaker, C. B., Bowden, E. F. & Dickey, M. D. Giant and switchable surface activity of liquid metal via surface oxidation. Proc. Natl. Acad. Sci. U. S. A. 111, 14047-14051 (2014).

1. Suspension or colloid comprising liquid metal droplets bound with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

2. Network of liquid metal droplets bound with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

3. Suspension, colloid, or network according to claim 1 or 2 wherein the liquid metal droplets are coated with graphene-based particles.

4. Suspension, colloid, or network according to any of the previous claims wherein the weight ratio between graphene-based particles to liquid metal droplets is 0.0001-0.5%, preferably 0.001-0.1%.

5. Ink comprising a concentrated network according to any of the claims 2-4, obtainable by separation of said network from a colloid or suspension according to claim 1.

6. Ink according to the previous claim obtainable by
suspending graphene-based particles in a first medium to obtain a first suspension, mixing liquid metal into the first suspension to obtain a mixture with the network of liquid metal droplets and graphene-based particles, and separating the concentrated network of liquid metal droplets and graphene-based particles from the mixture; or
suspending liquid metal droplets in a second medium to obtain a second suspension, mixing graphene-based particles into the second suspension to obtain a mixture with the network of liquid metal droplets and graphene-based particles, and separating the concentrated network of liquid metal droplets and graphene-based particles from the mixture.

7. Ink according to the claim 5 obtainable by suspending graphene-based particles in a first medium to obtain a first suspension and suspending liquid metal droplets in a second medium to obtain a second suspension, mixing said suspensions and separating the concentrated network of liquid metal droplets and graphene-based particles from the mixture, where the first medium and second medium are miscible.

8. Ink according to any of the claims 5-7 wherein the separating is carried out by precipitation, centrifuge, and/or filtering.

9. Ink according to any of the claims 6-8 wherein the first medium is water or an aqueous solvent, in particular both first medium and second medium are water or an aqueous solvent.

10. Ink according to any of the claims 6-9 wherein the second medium is ethanol or an alcohol-based solvent.

11. Printable ink according to any of the claims 5-10, further comprising a binder for improving ink adhesion and/or viscosity, in particular for improving ink adhesion and/or viscosity for nozzle extrusion or screen printing.

12. Conductor obtainable by applying a coating of suspension, colloid, network, or ink according to any of the previous claims over a substrate, and laser sintering said coating, in particular the conductor being an electrode or a circuit trace or a circuit.

13. Conductor according to claim 12, wherein the conductor is transparent or translucid.

14. Conductor according to any of the claims 12-13 wherein the conductor is flexible or stretchable.

15. Conductor according to any of the previous claims 12-14 wherein the coating is carried out by spraying, rod-coating, slot-die, inkjet printing, aerosol jet printing, or blade coating.

16. Conductor according to any of the previous claim 12-15 wherein the conductor comprises conductive patterns obtainable by laser patterning or lithography.

17. Process for obtaining a suspension or colloid, comprising binding liquid metal droplets with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

18. Process for obtaining a network of liquid metal droplets bound with graphene-based particles, comprising binding liquid metal droplets with graphene-based particles, wherein the liquid metal is gallium or a gallium alloy, and the graphene-based particles are selected from a list of graphene, graphene oxide, reduced graphene oxide, graphene quantum dots, carbon nanotubes, or combinations thereof.

19. Process for obtaining a suspension, colloid, or network according to claim 17 or 18 by coating liquid metal droplets with graphene-based particles.

20. Process for obtaining an ink comprising a concentrated network according to claim 18 or 19, by separating said network from a colloid or suspension.

21. Process for obtaining an ink according to the previous claim by:
suspending graphene-based particles in a first medium to obtain a first suspension, mixing liquid metal into the first suspension to obtain a mixture with the network of liquid metal droplets and graphene-based particles, and separating the concentrated network of liquid metal droplets and graphene-based particles from the mixture; or
suspending liquid metal droplets in a second medium to obtain a second suspension, mixing graphene-based particles into the second suspension to obtain a mixture with the network of liquid metal droplets and graphene-based particles, and separating the concentrated network of liquid metal droplets and graphene-based particles from the mixture; or
suspending graphene-based particles in a first medium to obtain a first suspension and suspending liquid metal droplets in a second medium to obtain a second suspension, mixing said suspensions and separating the concentrated network of liquid metal droplets and graphene-based particles from the mixture, where the first medium and second medium are miscible.

22. Process for obtaining an ink according to any of the claims 20-21 comprising separating by precipitation, centrifuge, and/or filtering.

23. Process for obtaining an ink according to any of the claims 21-22 wherein the first medium is water or an aqueous solvent, in particular both first medium and second medium are water or an aqueous solvent, in particular the pH of the aqueous solution containing graphene-based particles is between 1 to 6, preferably between 2 to 3.5.

24. Process for obtaining an ink according to any of the claims 21-23 wherein the second medium is ethanol or an alcohol-based solvent, in particular the liquid metal being 0.5-10% (w/w) of the ethanol or an alcohol-based solvent.

25. Process for obtaining a transparent or translucid conductor by applying a coating of suspension, colloid, network, or ink according to any of the claims 1-11 over a substrate, and laser sintering said coating, in particular the conductor being an electrode or a circuit trace or a circuit.

26. Process according to the previous claim wherein the coating is carried out by spraying, rod-coating, slot-die, inkjet printing, aerosol jet printing, or blade coating.

27. Process according to claim 25 or 26 wherein the laser is a fiber laser having a wavelength ranging from UV to IR.

28. Process according to any of the claims 25-27 comprising obtaining conductive patterns by laser patterning or lithography.

29. Process according to any of the claims 25-28 wherein the gallium alloy is an alloy of gallium-indium or gallium-indium-tin or eutectic gallium-indium.

30. Process according to any of the claims 17-29 wherein the weight ratio between graphene-based particles to liquid metal droplets is 0.0001-0.5%, preferably 0.001-0.1%.

31. Process to collect liquid metal particles from a suspension by adding a liquid suspension containing particles of opposite zeta potential than those of liquid metal for promoting a binding between the liquid metal and the added particles.

32. Device comprising a suspension, colloid or network according to any of the claims 1-4, an ink according to any of the claims 5-11, or a conductor according to any of the claims 12-16.

33. Device according to the previous claim wherein the device is an optoelectronic device, pressure or strain sensitive piezo resistive composite, a pressure or strain sensor, a temperature sensor, an electroluminescent device, a photovoltaic device, a memory device or an electrode for energy storage device.
